(19) United States
(12) Patent Application Publication
(10) Pub. No.: US 2012/0267939 A1
(43) Pub. Date: Oct. 25, 2012

(54) VEHICLE NET SEAT

(75) Inventor: Hiroki OTA, Inazawa-shi (JP)

(73) Assignee: TOYOTA BOSHOKU KABUSHIKI KAISHA, Aichi-ken (JP)

(21) Appl. No.: 13/450,814

(22) Filed: Apr. 19, 2012

(30) Foreign Application Priority Data
Apr. 21, 2011 (JP) 2011-094818

(51) Int. Cl. B60N 2/68

(52) U.S. Cl. 297/452.56

(57) ABSTRACT

A vehicle net seat includes a frame having a curved portion that inhibits interference with a buttock or hip of a seated person, and a net that is held taut over the frame and forms a backrest surface. An end portion on a seat cushion side of the net is held taut in a manner jutting out from the curved portion toward a seating side, such that a portion of a load from the seated person that is applied to the seat cushion is also received by a seat back.

### INCORPORATION BY REFERENCE

The disclosure of Japanese Patent Application No. 2011-094818 filed on Apr. 21, 2011 including the specification, drawings and abstract is incorporated herein by reference in its entirety.

### BACKGROUND OF THE INVENTION

1. Field of the Invention

The invention relates to vehicle net seat. More particularly, the invention relates to a vehicle net seat in which a net is held taut over a frame.

2. Description of Related Art

A net seat in which a net that forms a backrest surface for a seated person is held taut over a frame that forms a seat back is already known. Here, Japanese Patent Application Publication No. 2009-82526 (JP 2009-82526 A) describes a net seat 101 in which left and right lower sides of a portion of a frame 130 that forms a seat back 103 both curve toward the rear, as shown in FIGS. 4 and 5. In other words, the net seat 101 includes curved portions 132. As a result, the buttocks or hips of a seated person m that will be described later can be inhibited from interfering with the portion of the frame 130 that forms the seat back 103. Therefore, discomfort to the seated person m can be suppressed.

However, with the technology described in JP 2009-82526 A, the curved portions 132 are provided, so there may end up being a gap s between the back side of the buttocks or hips of the seated person m and a net 160, as shown in FIG. 6. If this kind of gap s occurs, the feeling of support at the buttocks or hips of the seated person m may end up being insufficient. In order to eliminate this, it is possible to have the left and right lower end sides of the portion of the frame 130 that forms the seat back 103 jut out forward. However, doing so may result in the buttocks or hips of the seated person m interfering with the portion of the frame 130 that forms the seat back 103, which would end up being uncomfortable to the seated person m.

### SUMMARY OF THE INVENTION

The invention thus provides a vehicle seat that provides a sufficient feeling of support for the buttocks or hips, without causing discomfort to a seated person.

A first aspect of the invention relates to a vehicle net seat that includes a frame having a curved portion that inhibits interference with a buttock or hip of a seated person, and a net that is held taut over the frame and forms a backrest surface. An end portion on a seat cushion side of the net is held taut in a manner jutting out from the curved portion toward a seating side. According to this structure, the end portion of the net that juts out to the seating side from the curved portion is able to support the back side of the buttocks or hips of a seated person. Therefore, unlike the related art, a feeling of support for the buttocks or the hips of the seated person is able to be inhibited from being insufficient. Also according to this structure, discomfort to the seated person is able to be suppressed, just like with the related art.

Also, a second aspect of the invention relates to a vehicle net seat that includes a frame having a curved portion that inhibits interference with a buttock or hip of a seated person, and a net that is held taut over the frame and forms a sitting surface. An end portion on a seat back side of the net is held taut in a manner jutting out from the curved portion toward a sitting side. According to this structure, operation and effects similar to those of the first aspect are able to be obtained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a vehicle net seat according to an example embodiment of the invention;

FIG. 2A is a longitudinal sectional view of FIG. 1;

FIG. 2B is a partial enlarged view of FIG. 2A;

FIG. 3 is a view showing a state in which an occupant is seated, in FIG. 2A;

FIG. 4 is a perspective view of a vehicle net seat according to related art;

FIG. 5 is a longitudinal sectional view of FIG. 4; and

FIG. 6 is a view showing a state in which an occupant is seated, in FIG. 5.

### DETAILED DESCRIPTION OF EMBODIMENTS

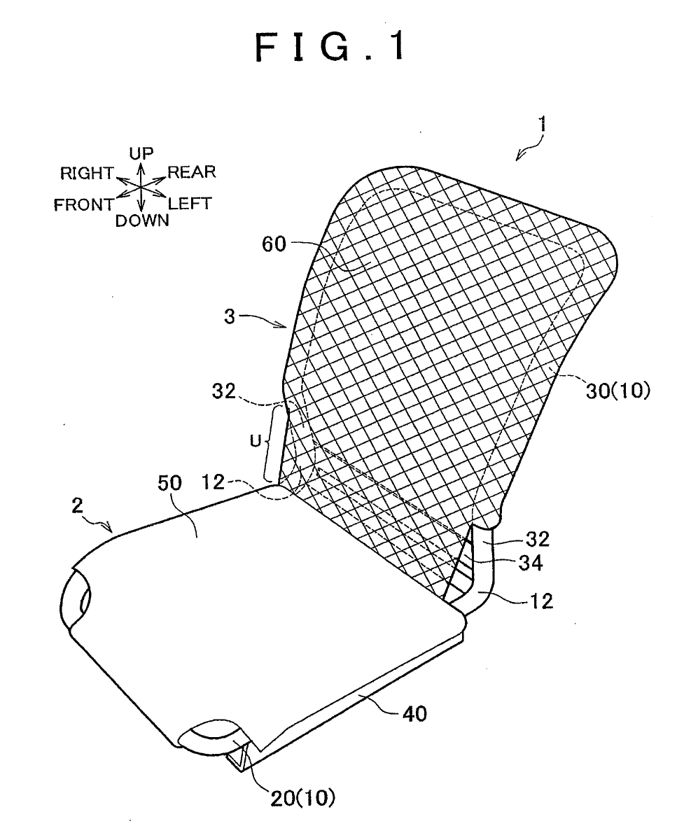

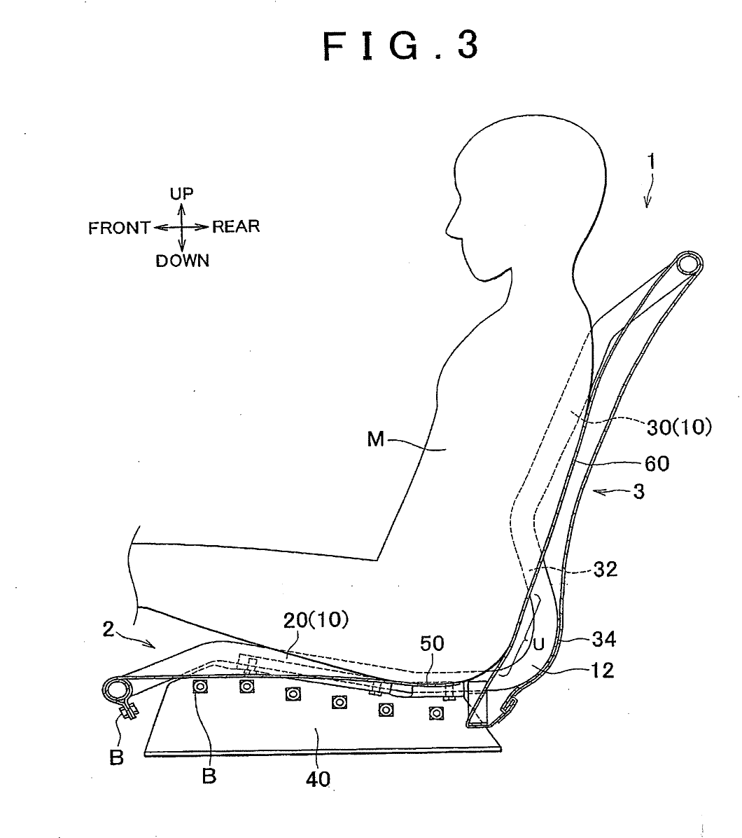

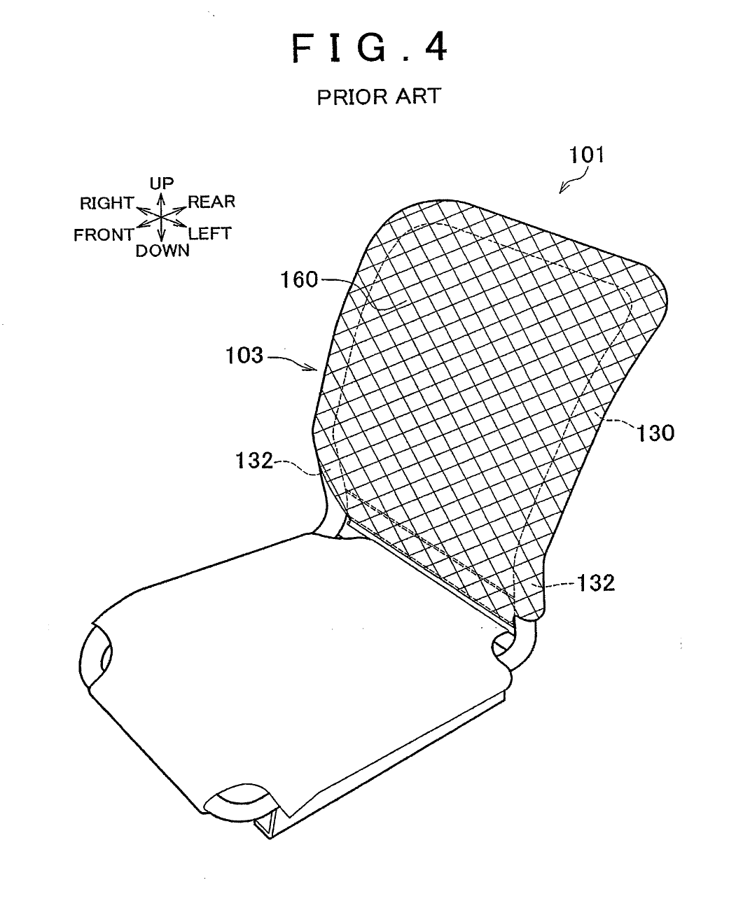

Hereinafter, example embodiments of the invention will be described with reference to FIGS. 1 to 3. In the description below, the terms up, down, front, rear (or back), left, and right indicate the directions of up, down, front, rear (or back), left, and right in the drawings, i.e., the directions of up, down, front, rear (or back), left, and right with respect to a vehicle net seat 1.

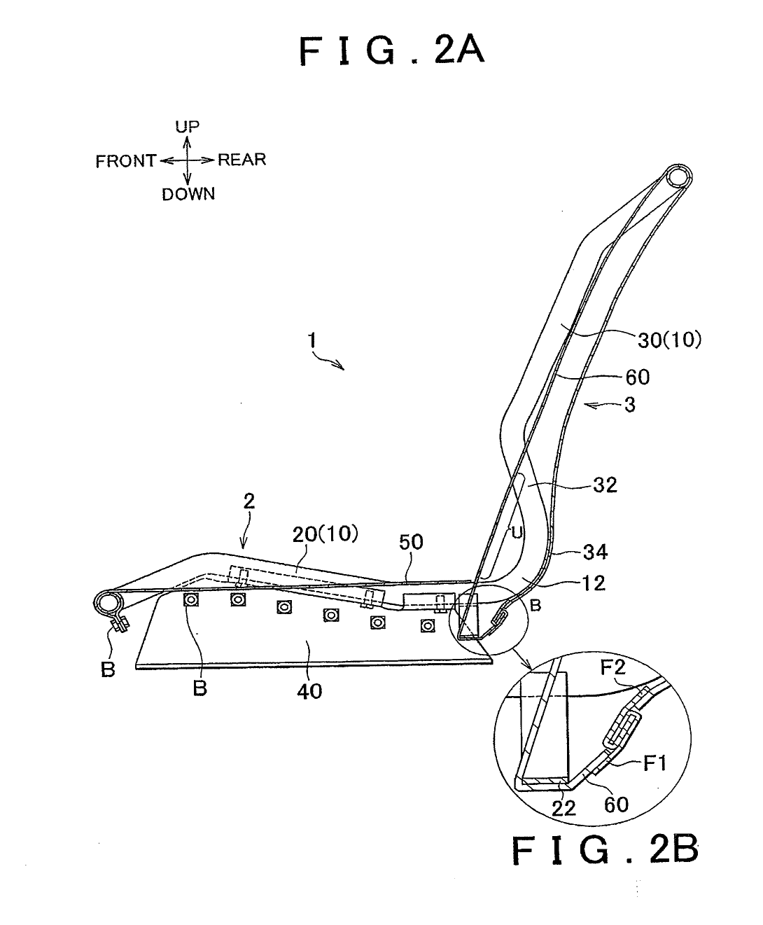

First, the structure of the vehicle net seat 1 according to an example embodiment of the invention will be described with reference to FIGS. 1 and 2. This vehicle net seat 1 mainly includes a frame 10 that forms the frame, and nets 50 and 60 (i.e., a cushion net 50 and a back net 60) that are held taut over the frame 10. These constituent members 10, 50, and 60 are described separately below.

First, the frame 10 will be described. The frame 10 is formed from two pipes that have been joined together at both ends so as to form a generally rectangular frame. Curved portions 12 that form boundaries between a portion that forms a seat cushion 2 and a portion that forms a seat back 3, are formed at substantially center portions in the longitudinal direction of the frame 10. For the sake of simplifying the description, the portion of the frame 10 that forms the seat cushion 2 will be referred to as the “cushion frame 20” and the portion of the frame 10 that forms the seat back 3 will be referred to as the “back frame 30.”

Lower arms 40 are assembled to the left and right of the cushion frame 20. However, the right lower arm 40 is not shown in FIG. 1. This vehicle net seat 1 is mounted to a floor, not shown, inside a vehicle via these left and right lower arms 40. Also, a bracket 22 that extends across the cushion frame 20 is assembled to the left and right rear ends (i.e., the front ends of the curved portions 12) of the cushion frame 20.

Meanwhile, curved portions 32 that curve toward the rear, similar to the related art, are formed on the left and right lower sides of the back frame 30. Also, a lower plate 34 that extends across of the back frame 30 is assembled to the left and right lower ends of the back frame 30.

Next, the cushion net 50 will be described. This cushion net 50 is made of a sheet-shaped cloth member that covers an opening of the cushion frame 20. A front edge of the cushion net 50 is held taut by bolts B to a front edge of the cushion frame 20, and the left and right edges of the cushion net 50 are held taut by bolts B to the lower arms 40.

Finally, the back net 60 will be described. The back net 60 is made of a bag-shaped cloth member that covers an opening of the back frame 30. This back net 60 is held taut over the back frame 30 in a manner slipped down over the back frame 30. A front edge of the taut back net 60 is wound back around toward the rear via the bracket 22 of the cushion frame 20 and fastened to a rear edge of the back net 60 by hooks F1 and F2 (see the partial enlarged view in FIG. 2B).

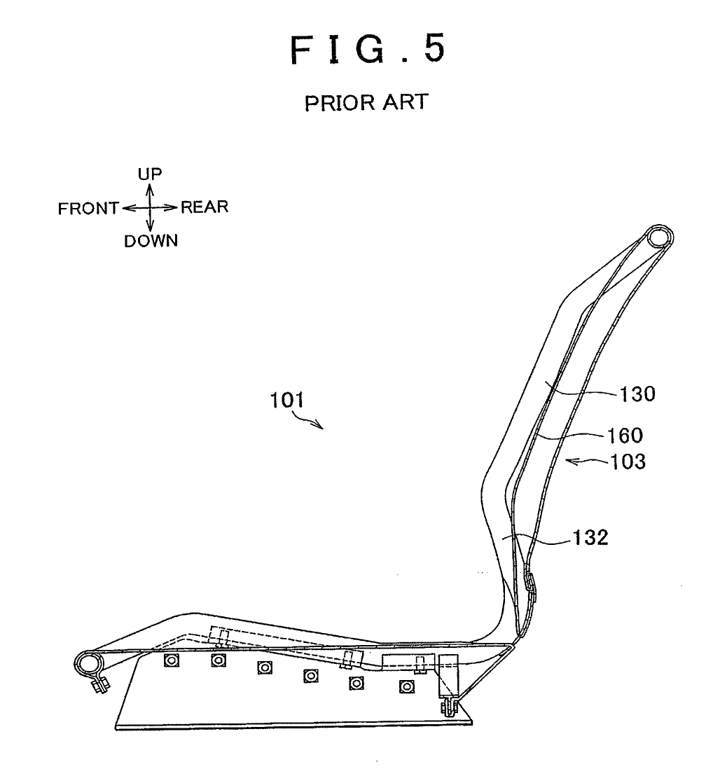

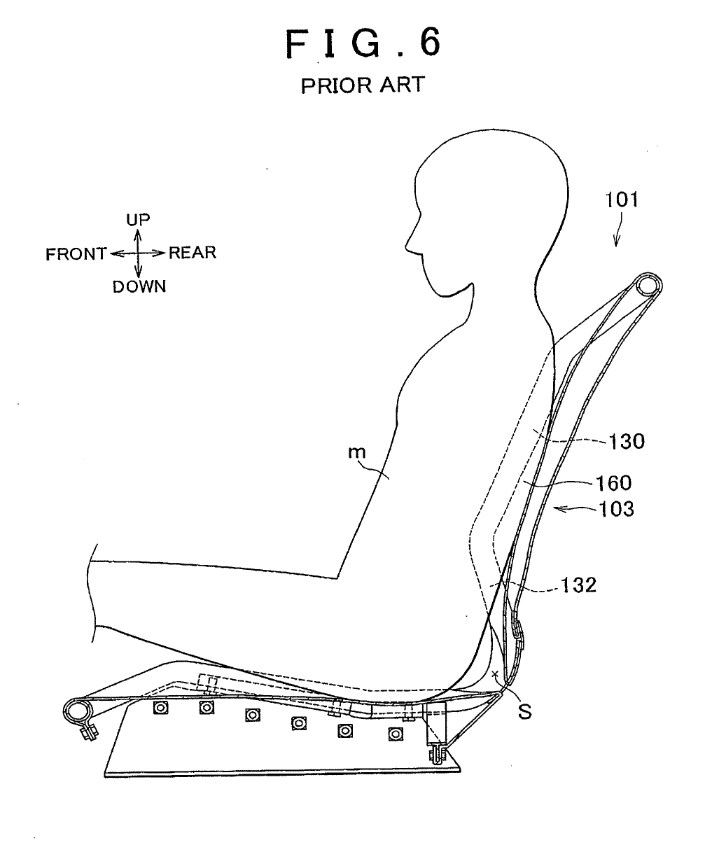

When the front edge of the taut back net 60 is wound back around in this way, a portion of the taut back net 60 below the upper end of the curved portion 32 (hereinafter this portion will be referred to as the “jutting out portion U”) juts out forward, as is also evident when comparing FIG. 2A with FIG. 5. When this portion juts out in this way, a portion of the load from a seated person M that is applied to the seat cushion 2 is also received by the seat back 3.

The vehicle net seat 1 according to this example embodiment is structured as described above. According to this structure, the jutting out portion U is formed on the back net 60. Thus, this jutting out portion. U is able to support the back side of the buttocks or hips of the seated person M. Therefore, unlike the related art, a feeling of support for the buttocks or the hips of the seated person M is able to be inhibited from being insufficient. Also according to this structure, the curved portions 32 that curve toward the rear are formed on the left and right lower sides of the back frame 30, similar to the related art. Therefore, discomfort to the seated person is able to be suppressed, just like with the related art.

The description above relates only to one example embodiment of the invention. The invention is not limited to this description. For example, in the example embodiment, the jutting out portion U is formed on the back net 60 side. However, the jutting out portion U may also be formed on the cushion net 50 side. In this case, the rear end side of the cushion net 50 has a structure similar to that of the lower end side of the back net 60.

Also, in the example embodiment, the back net 60 is formed in a bag shape. However, the back net 60 may also be formed in a sheet shape. In this case, an upper edge of the back net 60 may be held taut by bolts to an upper edge of the back frame 30, and left and right edges of the back net 60 may be held taut by bolts to left and right edges of the back frame 30. When the back net 60 is formed in a sheet shape, a resin frame into which the back net 60 has been inserted may be insert formed, and this formed resin frame may be assembled to the back frame 30.

Also in the example embodiment, the front edge of the back net 60 is wound around toward the rear via the bracket 22 of the cushion frame 20, and fastened to the rear edge of the back net 60 via the hooks F1 and F2. However, the front edge of the back net 60 may also be fastened to the bracket 22 of the cushion frame 20 via the hook F1, and the rear edge may be fastened to the lower plate 34 of the back frame 30 via the hook F2.

The curved portions 32 may also be provided on extended portions that extend the rear end of the cushion frame 20 upward.

What is claimed is:

1. A vehicle net seat comprising:
a frame having a curved portion that inhibits interference with a buttock or hip of a seated person; and
a net that is held taut over the frame and forms a backrest surface,
wherein an end portion on a seat cushion side of the net is held taut in a manner jutting out from the curved portion toward a seating side.

2. The vehicle net seat according to claim 1, wherein a lower end portion of the net is held taut so as to jut out most toward the seating side, at the backrest surface.

3. The vehicle net seat according to claim 1, wherein a bracket that extends across the frame is assembled to a seat cushion side end portion of the curved portion of the frame, and a lower end portion of the net is held taut over the bracket.

4. A vehicle net seat comprising:
a frame having a curved portion that inhibits interference with a buttock or hip of a seated person; and
a net that is held taut over the frame and forms a sitting surface,
wherein an end portion on a seat back side of the net is held taut in a manner jutting out from the curved portion toward a sitting side.
